(19) United States
(12) Patent Application Publication
(10) Pub. No.: US 2004/0210913 A1
(43) Pub. Date: Oct. 21, 2004

(54) Method of accessing resource description framework based information

(76) Inventors: Jason A. Kinner, Marlton, NJ (US); Richard Friedman, Cherry Hill, NJ (US); Joseph J. Snyder, Shamong, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,956

(22) Filed: Apr. 17, 2003

(51) Int. Cl. G06F 9/46

(52) U.S. Cl. 719/328

(57) ABSTRACT

A method for using a component technology based software system to access a Jena application program interface (API).

### BACKGROUND

Resource Description Framework (RDF), as defined by the World-Wide Web Consortium (W3C), may be a model for storing information. More particularly, the RDF model may be designed for storing of information about information—METADATA. METADATA in the RDF model is grouped using a logical triple. In its simplest form, the triple may comprise a subject, a predicate and an object. For example, the statement “Leslie is 34 years old” may be broken down into the triple subject=Leslie, predicate=age, and object=“34.” Thus, the predicate that links the subject “Leslie” to the object “34” may be the property ‘age.’ In more technical terms, the triple of the RDF model may be defined by a resource (subject), property (predicate), and object. Although the resource in the simple example given above was “Leslie,” in the RDF model a resource may be anything which may be assigned a Universal Resource Identifier (URI). One example of the resource that may be assigned an URI is a document posted to the world-wide web. A document with a URI may be as simple as a digital image, or may be as complex as a series of commands read by a web browser to create a viewable web page.

The RDF model may not define properties or predicates; rather, the RDF model may only define the relationship of storing METADATA in the form of a triple. Thus, the general population may be free to define any series of properties which may be relevant to their particular genre of subjects. Each of these defined set of properties may be referred to as a schema, a RDF schema, or a “namespace.”

### SUMMARY

For the METADATA to be useful, user programs may need to access METADATA. While there may be application program interfaces (APIs) designed to access METADATA coded in an RDF framework, those APIs may need to be accessible to both local and distributed software programs for the METADATA to be fully utilized.

This problem may be solved in large part by using a component technology based software system to access a Jena application program interface (API).

### BRIEF DESCRIPTION OF THE DRAWINGS

For a detailed description of the embodiments of the invention, reference will now be made to the accompanying drawings in which:

FIG. 1 may illustrate, in block diagram form, a high level overview of representative embodiments;

FIG. 2 may illustrate use of Enterprise JavaBeans™ in accordance with representative embodiments;

FIG. 3 may illustrate use of Common Object Request Architecture (CORBA) in accordance with representative embodiments; and

FIG. 4 may illustrate use of Component Object Model (COM) and Distributed Component Object Model (DCOM) in accordance with representative embodiments.

### NOTATION AND NOMENCLATURE

Certain terms are used throughout the following description and claims to refer to particular components and systems. As one skilled in the art will appreciate, computer and software companies may refer to a component by different names. This document does not intend to distinguish between components and systems that differ in name but not function. In the following discussion and in the claims, the terms “including” and “comprising” are used in an open-ended fashion, and thus should be interpreted to mean “including, but not limited to.”.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments of the present invention may be directed to making METADATA, coded using the RDF model, available to various software component technologies. In various embodiments of the invention, the primary application program interface (API) for accessing the RDF-based information may be Jena. Jena is a publicly available API, which may be obtained from Hewlett-Packard's website: http://www.hpl.hp.com/semweb/download.htm. Jena may be used to access information coded based on the RDF model. More particularly, Jena may be a Java language based API that is capable of reading, writing, and other such tasks, extensible markings language (XML) coded information based on the RDF model. The Jena API may be used independent of the schema or schemas used in the RDF coded information, as Jena may have the capability of accessing properties after discovery of the properties defined in the particular schema.

Component technology may be ‘off-the-shelf’ software programs used by developers to create software applications. Rather than a programmer starting with a blank page, coding an entire system, and then de-bugging such a system, component technologies may allow the programmer to modularly piece together previously written and tested software “components” to perform the desired task. Thus, embodiments of the invention may be directed to allowing software component technologies to access METADATA coded using the RDF model, possibly accessing that METADATA by way of a Jena API.

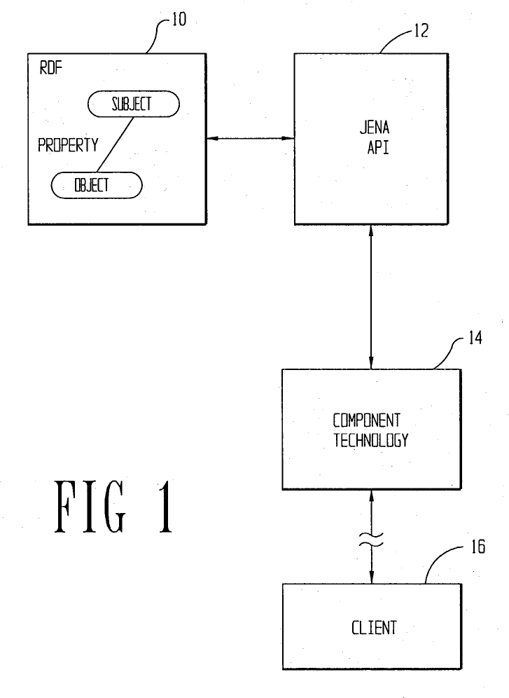

FIG. 1 may illustrate, in block diagram form, embodiments of the present invention. In particular, embodiments of the invention may include RDF database 10 comprising information possibly coded using an RDF model. Access to the RDF database 10 may be accomplished through an API, such as Jena API 12. As previously mentioned, the Jena API 12 may have the ability to look within the RDF database 10 to determine various properties coded therein, and allow external programs to access and/or modify the relationships in the RDF database 10. In embodiments of the present invention, various component technologies 14, discussed more thoroughly below, may access METADATA within the RDF model 10 through the Jena API 12. The various component technologies 14 may thus allow client programs 16 access to the RDF database 10, possibly independent of the programming language of the client 16.

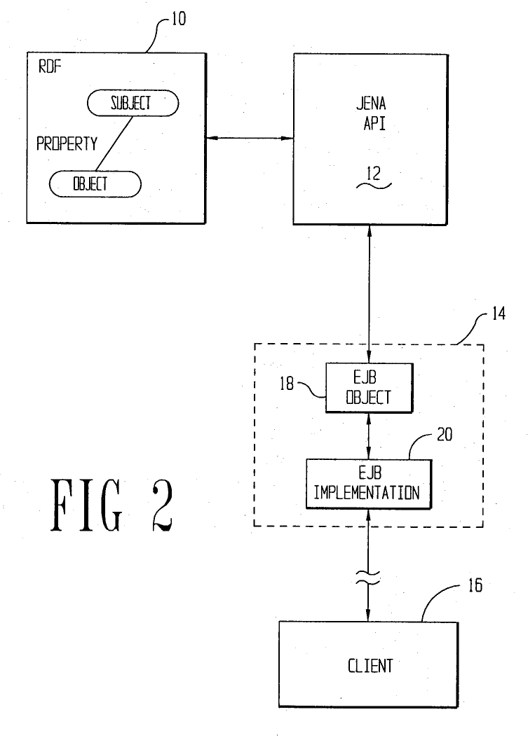

In at least some embodiments of the invention, the component technology 14 may be components based on the Enterprise JavaBeans™ (EJB) system, as illustrated in FIG. 2. EJB may be an open-source component technology, thus allowing integration of third party components to form an overall system. For more information regarding EJB, reference may be made to the Enterprise JavaBeans™ proposed final draft, available at: http://java.sun.com/products/ejb/docs.html, which final draft is incorporated herein by reference as if reproduced in full below.

Thus, at least some embodiments of the invention may comprise creation of a Java language based EJB object 18 as illustrated in FIG. 2. From the EJB object, an EJB system may create the EJB implementation 20. The combination of the EJB object 18 and the EJB implementation 20 may thus form the mechanism through which a client 16 (also possibly programmed using EJB technology) may facilitate access to the RDF database.

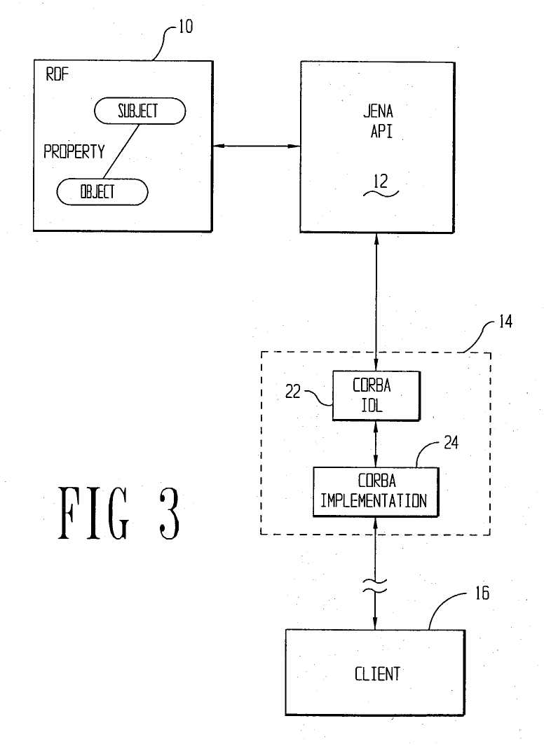

Referring now to FIG. 3, there may be shown further embodiments of the present invention. In particular, FIG. 3 may show the component technology 14 as a Common Object Request Broker Architecture (CORBA) based system. Thus, embodiments of the invention may comprise creation of a CORBA control document 32, possibly in an Interface Definition Language (IDL) format. CORBA, much like EJB, may be a component technology based system for communication of data to and from remote clients and objects. While in some cases the clients and objects may reside on the same computer, the standard may transparently allow communication over physical or logical distances. For more information about the CORBA standard, reference may be made to the CORBA specification, available at http://www.omg.org/technology/documents/formal/corba_{—}2.htm, which standard is incorporated by reference herein as if reproduced in full below.

In relevant part to the embodiments of the present invention, the object side in a CORBA compliant system may define available services and information by a CORBA control document 22 in IDL. IDL may be a programming language independent operational interface. The underlying communication protocol for a CORBA system is InternetInterORB Protocol (IIOP), although CORBA based systems are necessarily limited to this protocol. From the CORBA control document in IDL, an underlying CORBA system may generate a Java-based CORBA implementation 24. The combination of a CORBA IDL 22 and CORBA implementation 24 may thus form a mechanism through which a client 16 (also possibly programmed using CORBA) may facilitate access to the RDF database.

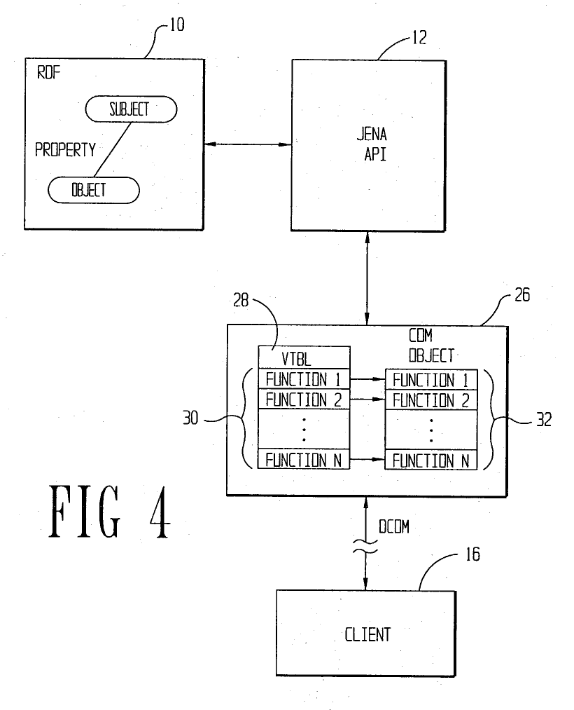

Referring now to FIG. 4, there may be shown further embodiments of the present invention. In particular, FIG. 4 may show component technology 14 in the form of a Component Object Model (COM) object 26. COM may be a software architecture that allows components made by varying software vendors to be combined to form applications. In particular, COM may define a standard for interoperability that is not dependent on any single programming language. For more information regarding COM, reference may be made to: http://www microsoft.com/com/.

In relevant part to the embodiments of the present invention, the COM object 26 may comprise a virtual function table (VTBL) 28. Other COM objects, such as client 16, may obtain access to the various methods of the COM object through a pointer to the VTBL 28. The VTBL 28, in turn, may contain a series of function pointers 30. The function pointers, in turn, may point to particular methods 32. In accordance with the COM standards, these methods may be implemented in any programming language to perform their desired tasks. In accordance with embodiments of the present invention, the methods 32 communicate to the Jena API 12, which in turn may communicate to the RDF database 10. Thus, using the COM technology, other objects, such as client 16, may access and/or modify information in the RDF database 10 by discovering and utilizing the methods of the COM objects 26.

Generally speaking, the COM technology may easily allow COM objects residing within the same address space as the COM object 26 to access and/or modify information in the RDF database 10 (possibly by communication with the Jena API 12). Further, the COM system architecture may have limited capabilities for allowing remote objects, e.g., objects within the same hardware but within a different address space, as well as hardware on separate machines, to remotely access the COM object 26 and its methods 32. However, embodiments of the present invention may also use an extension of the COM technology known as Distributed Components Object Model (DCOM) to facilitate remote object access to the COM object 26. In particular, DCOM may allow relatively transparent communication between objects executing on machines remote from each other. DCOM may provide functionality, such as fault-tolerance in case of hardware failures, handling of network failures, and may also be capable of distributing network traffic, all as a set of prepackaged component technologies that the individual developer need not be concerned with implementing. For further information regarding DCOM, reference may be had to: http://www.microsoft.com/com/teck/DCOM.asp.

Thus, in some embodiments of the invention, DCOM may provide the necessary functionality for implementing the communication between the client 16 and the COM object 26, possibly by providing proxies to give the local objects the impression that they are communicating with objects executing in their own address space. It should be understood, however, COM alone may have some of this functionality, and thus DCOM is not necessarily required. Further, other communication systems may be used in combination with COM to facilitate the remote access functionality.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
accessing Resource Description Framework (RDF) based information by:
utilizing a Jena application program interface (API); and
using a component technology based software system to access the Jena API.

2. The method as defined in claim 1, wherein using a component technology further comprises:
creating an Enterprise JavaBeans (EJB) object; and
creating an EJB implementation based on the EJB object to access the Jena API.

3. The method as defined in claim 1, wherein using a component technology further comprises:
creating a Common Object Request Broker Architecture (CORBA) control document; and
generating a CORBA implementation based on the CORBA control document to access the Jena API.

4. The method as defined in claim 3, wherein generating a CORBA implementation further comprises:
supplying the CORBA control document to a CORBA system; and
generating, by the CORBA system, the CORBA implementation to access the Jena API.

5. The method as defined in claim 1, wherein using a component technology further comprises using a virtual function table, storing a pointer to a method, and wherein the virtual function table and method are compliant with Common Object Model (COM) standard for interoperability.

6. The method as defined in claim 5, wherein using the virtual table further comprises using a virtual function table and method that are compliant with Distributed Common Object Model (DCOM) standard for interoperability.

7. A computer readable media storing files, the files comprising a file that defines parameters for access by component technology software to a Jena application program interface (API).

8. The computer readable media as defined in claim 7 wherein the file comprises an Enterprise JavaBeans (EJB) object.

9. The computer readable media as defined in claim 7 wherein the file comprises a Common Object Request Broker Architecture (CORBA) control document coded in Interface Definition Language (IDL).

10. A computer readable media storing files, the files comprising a virtual function table storing a pointer to a method that accesses information stored based on a resource description framework (RDF) through a Jena application program interface (API).

11. The computer readable media as defined in claim 10 wherein the virtual function table file and method are compliant with Common Object Model (COM) standard for interoperability.

12. The computer readable media as defined in claim 11 wherein the virtual function table file and method are compliant with Distributed Common Object Model (DCOM) standard for interoperability.

13. A method comprising:
combining a software component technology with a Jena application program interface (API); and thereby
making information coded based on a Resource Description Framework (RDF) accessible to client software.

14. The method as defined in claim 13 wherein the combining further comprises:
creating an Enterprise JavaBeans (EJB) object;
creating an EJB implementation based on the EJB object; and
using the EJB implementation and the Jena API to access the information coded in RDF.

15. The method as defined in claim 13 wherein the combining further comprises:
creating a Common Object Request Broker (CORBA) control document;
generating a CORBA implementation based on the CORBA control document; and
using the CORBA implementation and the Jena API to access the information coded in RDF.

16. The method as defined in claim 13 wherein the combining further comprises:
creating a virtual function table, the virtual function table storing a pointer to a method, and wherein the table and method are compliant with Common Object Model (COM) standard for interoperability; and
using the virtual function table and method with the Jena API to access the information coded in RDF.

17. The method as defined in claim 13 wherein the combining further comprises:
creating a virtual function table, the virtual function table storing a pointer to a method, and wherein the table and method are compliant with Distributed Common Object Model (DCOM) standard for interoperability; and
using the virtual function table and method with the Jena API to access the information coded in RDF.

18. A computer readable media storing programs executable by a computer, the programs comprising a program that allows access by component technology software to a Jena application program interface (API).

19. The computer readable media as defined in claim 18 wherein the program comprises an Enterprise JavaBeans (EJB) based implementation.

20. The computer readable media as defined in claim 18 wherein the program comprises a Common Object Request Broker Architecture (CORBA) implementation.

21. The computer readable media as defined in claim 20, wherein the CORBA implementation is created by supplying a CORBA control document coded in Interface Definition Language (IDL) to a CORBA system.
